(19) United States
(12) Patent Application Publication
(10) Pub. No.: US 2025/0131357 A1
(43) Pub. Date: Apr. 24, 2025

(54) System and Related Methods for Warehouse Optimization Utilizing Multi-Point Camera Feedback and AI-Driven Complexity Assessment

(71) Applicants: Isura Ranatunga, Concord, CA (US); Channa Ranatunga, Grand Prairie, TX (US); Sandeep Suresh, Emeryville, CA (US)

(72) Inventors: Isura Ranatunga, Concord, CA (US); Channa Ranatunga, Grand Prairie, TX (US); Sandeep Suresh, Emeryville, CA (US)

(21) Appl. No.: 18/382,476

(22) Filed: Oct. 21, 2023

(51) Int. Cl. G06Q 10/0633; G06V 20/52

(52) U.S. Cl. CPC G06Q 10/0633; G06V 20/52

(57) ABSTRACT

The invention relates to a warehouse optimization system employing 2D and 3D machine vision for assessing item-picking complexity in containers. The system uses multiple cameras situated at different points within the warehouse to capture data pertaining to both human and robot item-picking processes. A set of servers evaluate this data to decide the most suitable approach—manual or automated—for item picking. Additionally, the system determines the effectiveness of various robotic end effectors. Metrics derived from the cameras influence decisions such as whether items are sent to human or robotic work cells. The system is particularly applicable to e-commerce warehouses transitioning from manual to automated operations.

### FIELD OF INVENTION

The present invention relates generally to the field of warehouse management systems, specifically to systems and methods that utilize machine vision and artificial intelligence for optimizing item-picking processes in a warehouse environment.

### BACKGROUND

In modern warehouses and manufacturing plants, automation has increasingly become the standard for streamlining various operations. However, the automation of individual item picking remains a complex and elusive task, presenting numerous challenges. One of the key issues stems from the variable maturity levels of available robotic solutions for item picking, which leads to an uncertain landscape for warehouse managers considering the implementation of automation. The maturity level of robotic solutions varies widely across vendors, leading to difficulties in determining the suitability of specific robotic systems for particular applications within the warehouse environment.

Additionally, the complexities of manipulating items within containers add another layer of challenge. Different materials, sizes, and shapes of items can complicate the grasping mechanisms of robotic systems. Furthermore, the complexities do not only arise from the material profiles but also from the arrangement of items within containers, which can vary considerably. Traditional systems often lack the capabilities to assess the complexity of these item arrangements in real-time, which is crucial for optimizing the picking process.

The matter is further complicated by the presence of both human and robotic picking operations within the same environment. Human workers exhibit diverse grasping styles and techniques, information which is often invaluable for designing effective robotic end effectors. However, most existing systems do not consider human grasping metrics when evaluating the complexity involved in picking tasks. This leads to a fragmented understanding of the overall operation and results in inefficiencies.

Another limiting factor in current systems is the difficulty in assessing and comparing the performance of different robotic work cells, particularly when they are from different vendors. Often, a warehouse might employ robotic solutions from multiple vendors, each with their unique capabilities and limitations. A lack of standardized metrics for evaluating the probability of successful item picking across different robotic work cells makes it challenging to manage and optimize the workflow efficiently.

Moreover, the dynamic nature of warehouse operations—where containers may be routed through different picking stations based on real-time decisions—further emphasizes the need for a sophisticated system capable of making quick and accurate assessments. Unfortunately, existing systems typically fall short in this area, as they lack the capability to adapt in real-time to changing conditions, relying instead on pre-set configurations that may not be optimal for all situations.

Therefore, there is a distinct need for a system that can navigate these complexities by assessing various metrics from both human and robotic item-picking processes to enable more informed decision-making for warehouse optimization.

WO2022125269A1 describes an automated parts handling system which includes a conveyor, a robotic arm configured to pick parts from a parts receptacle and place the picked parts on the conveyor, a vision device disposed over or adjacent the conveyor and configured to determine the number of parts picked by the robotic arm from the parts receptacle and placed on the conveyor, a memory, and a processor communicatively coupled to the conveyor, the robotic arm, and the vision device. The memory includes program instructions executable by the processor to implement a pick process configured to receive information from the vision device on the number of parts picked by the robotic arm and placed on the conveyor, based on the received information regarding the number of picked parts, selectively control the robotic arm to retrieve from the conveyor a number of the picked parts, and selectively control the robotic arm to place one or more of the retrieved parts back in the parts receptacle when the number of parts picked by the robotic arm differs from a predetermined number of parts specified in the program instructions.

U.S. Pat. No. 11,338,436B2 describes systems for assessing a robotic grasping technique. The system in accordance with various embodiments may include a warehouse management system for retrieving and storing items, a robotic manipulator for grasping an item, and analysis module configured to receive data regarding a first grasp attempt by the robotic manipulator and analyze the received data to determine whether the robotic manipulator successfully grasped the item.

Neither of the prior art solutions describe a system capable of factoring in grasp complexity into a decision-making system in a hybrid human and robot work cell warehouse environment.

It is within this context that the present invention is provided.

### SUMMARY

The invention pertains to a warehouse optimization system that employs 2D and 3D machine vision to analyze metrics relevant to item picking in a warehouse. The system evaluates the complexity involved in picking items from containers and makes decisions based on an AI model, determining whether the picking process should be manual or automated. The AI model also identifies the most suitable robotic end effectors for automated picking when applicable.

In some embodiments, the system includes multiple cameras placed at strategic points throughout the warehouse. The first camera is located above conveyors at a decision point before the conveyor forks. This camera observes container utilization and item layout, grading each container based on its layout complexity. Among the metrics determined are the percentage of container volume filled, item visibility percentage, barcode visibility percentage, and flat surface percentage. The camera also maintains a history of container view changes at different stages.

In some embodiments, a second camera is placed to monitor human picking stations. This camera observes the manipulation complexity involved in human item picking for each item or order line. It classifies human grasp using the GRASP taxonomy and measures the smoothness of the pick motion. Metrics like grasp type, opposition type, and virtual finger assignments are determined to understand the nuances of human picking operations.

In some embodiments, a third camera is designated to monitor robotic picking stations. Similar to the second camera, this camera focuses on determining the manipulation complexity for robotic item picking for each item or order line. The camera classifies the grasp types of end effectors and tracks the smoothness of the pick motion. The metrics generated by this camera serve to gauge the efficacy and appropriateness of different robotic end effectors for picking specific types of items.

In some embodiments, the system uses the metrics extracted from all the cameras to calculate a measure of picking complexity and a probability of successful picking for both human and robotic work cells. When the probability of successful picking by a robotic work cell surpasses a predefined threshold, the system can reroute items to that robotic work cell.

In some embodiments, the system can assess robotic work cells from different vendors and redirect items to the work cell most likely to execute successful picks. The picking complexity and pick success probability are used as criteria for making these decisions.

Thus, according to a first aspect of the present disclosure, there is provided a warehouse optimization system comprising: a first camera device positioned above a conveyor before a fork point, configured to capture data related to container utilization and item layout in the container, the first camera being further configured to generate a first set of metrics based on the container contents and arrangement; a second camera device positioned to monitor a human picking station, the second camera being configured to capture data related to manipulation complexity in human item picking and to generate a second set of metrics; a third camera device positioned to monitor a robotic picking station, the third camera being configured to capture data related to manipulation complexity in robotic item picking and to generate a third set of metrics; and one or more servers.

The one or more servers are configured to: execute an artificial intelligence (AI) model, the AI model being configured to receive the metrics generated by the first camera, the second camera, and the third camera and to evaluate a measure of picking complexity and a probability of picking success for a given item based on said metrics; and execute a warehouse control system that receives the measure of picking complexity and the probability of picking success from the AI model and controls the conveyor to direct the given item to a human work cell or a robotic work cell based on the measure of picking complexity and the probability of picking success.

### BRIEF DESCRIPTION OF THE DRAWINGS

Various embodiments of the invention are disclosed in the following detailed description and accompanying drawings.

FIG. 1 shows an example method for monitoring and optimizing item picking in a warehouse. It outlines the activation of an artificial intelligence model and multiple cameras for capturing metrics concerning human and robotic picking activities and the traits of containers in motion.

FIG. 2 shows an example system overseeing both human and robot work cells, comprising an array of camera systems and conveyors. It illustrates the movement of items on the conveyors and their interaction with the cameras.

In FIG. 3 shows another example system with the capability to assess the performance of various robotic end effectors. It underlines the role of the AI Decision Engine in determining the suitability of items for robotic picking.

FIG. 4A shows example image data from the first camera being used to determine SKU visibility.

FIG. 4B shows example image data from the first camera being used to determine the visibility of barcodes on the SKUs within a container.

FIG. 4C shows example image data from the first camera being used to determine the flat surface area within a container.

FIG. 4D shows example image data from the first camera being used to capture a layout history of a container as it moves through a warehouse environment.

FIG. 5 shows example image data captured by the second camera being used to assess a grasping motion as a human hand picks up an SKU.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

### DESCRIPTION OF DRAWINGS

The present invention relates to systems and methods for optimizing item-picking operations in a warehouse environment, particularly in scenarios involving a mix of human and automated picking processes. The invention employs a plurality of cameras, including 2D and 3D machine vision cameras, positioned at strategic locations within the warehouse to capture a variety of metrics related to item-picking complexity from containers on conveyors. These metrics are processed and analyzed by an artificial intelligence model to make determinations regarding the most appropriate method for picking items-whether it be manual or automated. In cases where an automated process is deemed suitable, the system also evaluates the efficacy of different robotic end effectors for the given task.

The system captures data through multiple cameras at designated points, such as the point where containers arrive at a picking station, human-operated picking stations, and robotic picking stations. Each camera serves a specific role in collecting metrics that contribute to the overall assessment of picking complexity. These metrics include, but are not limited to, the utilization of container volume, the visibility of barcodes and items, and the feasibility of using suction cup solutions. Additional metrics gathered from human and robotic picking stations include details about the nature of grasps employed for picking and the smoothness of the pick path.

The AI model utilizes the captured metrics to make decisions that govern the flow of containers in the warehouse. These decisions may include redirecting a container to either a human or robotic work cell, based on calculated probabilities of successful item picking. The system is particularly useful for large e-commerce warehouses that are in the process of transitioning from manual to automated picking operations, as it allows for a graded approach to automation based on real-time assessments of picking complexity.

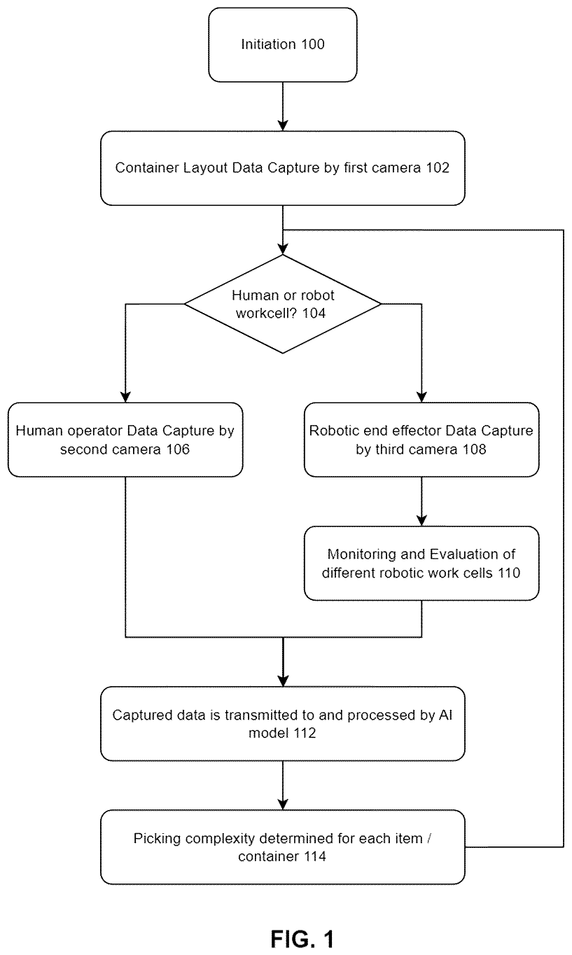

Referring to FIG. 1, a process flow diagram is shown. The method begins with the initiation of the system 100. This entails activating the artificial intelligence model and the various cameras positioned throughout the warehouse. These cameras are specifically designed to capture metrics related to both human and robotic item picking activities as well as the characteristics of the containers moving through the warehouse.

Following system initiation, the first camera captures a wide array of metrics as containers pass beneath it 102. These metrics include, but are not limited to, the percentage of the container volume that is filled, the visibility of items within the container, and the visibility of barcodes attached to items within the container. This data is essential for understanding how well the items in each container can be seen and accessed, both by human pickers and automated systems.

A decision is then made on whether to send each container to a human work cell or a robotic end effector work cell 104.

The second camera monitors human picking stations 106. At these stations, the camera observes the methods human operators use to pick items from containers. Specific metrics captured include the type of grasp used by human operators, which is classified according to a standardized grasp taxonomy, and the smoothness of the pick path. The latter is calculated based on a specific equation that evaluates the maximum amplitude of the trajectory involved in the picking motion.

$${J}_{α} = {\int }_{{t}_{1}}^{{t}_{2}} {x}^{...} {( t )}^{2} dt \frac{{( {t}_{2} + {t}_{1} )}^{5}}{{A}^{2}}$$

In the evaluation of pick path smoothness by the second camera, a mathematical metric Ja is utilized. This metric quantifies the smoothness of the trajectory followed during the pick.

x″(t)² denotes the second derivative of the trajectory x(t) with respect to time, essentially representing the acceleration of the trajectory.

The integral evaluates the squared acceleration over the time interval [t1, t2], thereby summing the instantaneous contributions of the acceleration magnitudes throughout the pick process.

The term (t2-t1)⁵ is a temporal scaling factor that accounts for the duration of the pick process.

A is the maximum amplitude of the trajectory x(t), which normalizes the entire expression by squaring its value in the denominator.

The resultant metric Ja effectively captures the extent of abrupt changes or jerks in the pick path. A smaller value of Ja indicates that the trajectory is smoother with fewer abrupt changes, while a larger value signifies more rapid or erratic alterations in the pick path. Therefore, for optimal picking operations, the objective would be to achieve trajectories with minimized Ja values, ensuring smooth and efficient item retrieval.

Simultaneously, the third camera monitors the robotic picking stations 108. Similar to the metrics captured for human picking, this camera captures data on the types of grasps employed by robotic end effectors as well as the smoothness of their pick paths. These metrics are important for comparing the effectiveness of different robotic systems in picking items from containers.

In some embodiments, the method incorporates an additional step of evaluating different vendor-specific robotic work cells 110. The artificial intelligence model uses its calculated measures and probabilities to determine which robotic work cell, from among several that might be provided by different vendors, is most likely to successfully pick items from each container.

All captured data is then sent to the artificial intelligence model for analysis 112. The AI model uses algorithms to calculate a measure of the complexity involved in picking items from each container 114. This complexity measure encapsulates the likelihood of successful picking by both human pickers and automated systems with different types of end effectors or grippers.

The artificial intelligence model uses the calculated complexity measures to influence the control of a conveyor system, feeding the data back into the control system that determines where items are sent at step 104. Based on the complexity measures and calculated probabilities, items on the conveyor are directed either to automated picking stations or to stations manned by human operators.

The method also features ongoing updates to complexity assessments. As new data are continuously fed into the AI model, the model regularly updates its complexity calculations and picking success probabilities. These continuous updates enable the warehouse optimization system to adapt to changing conditions in real-time.

The system records and stores of all pertinent metrics, analyses, and system decisions. This ensures that valuable data are preserved for future auditing and for the ongoing improvement of the system.

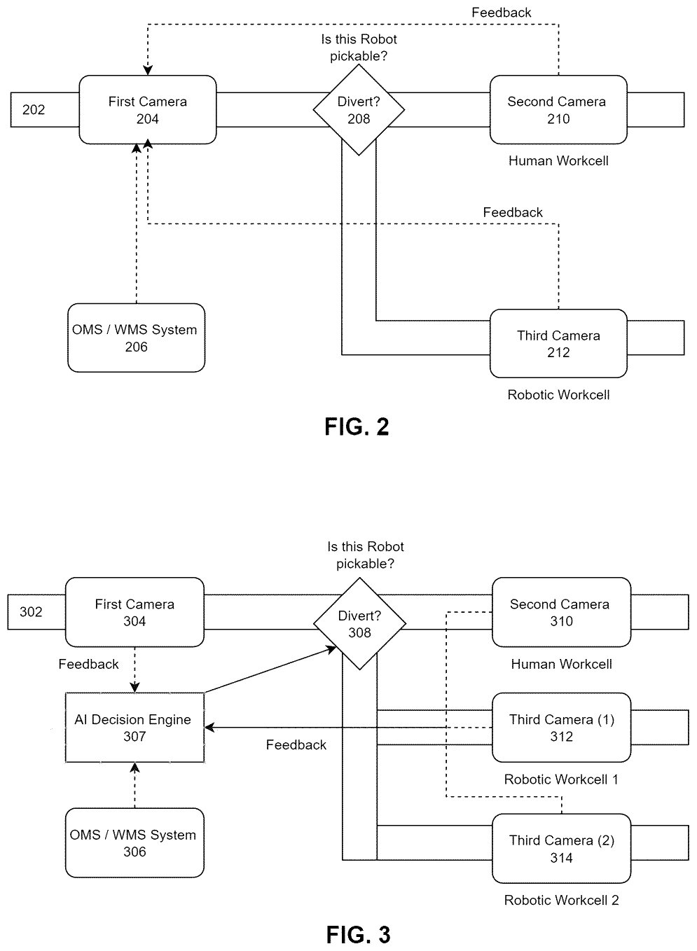

Referring to FIG. 2, an overview of a first embodiment of the system monitoring both human and robot work cells is presented. The system comprises multiple camera systems and conveyors that interact with both human and robot workflows.

At the leftmost part of the diagram, a conveyor 202 transports items to be viewed by the first camera 204. This camera system is primarily responsible for obtaining a view of the item layout within a container. This visual information, in conjunction with container details sourced from an external system such as an Order Management System (OMS), Warehouse Management System (WMS), or Warehouse Control System (WCS) 206, enables a decision to be made 208 about where to divert the container—to a human workcell monitored by a second camera 210, or to a robotic workcell monitored by a third camera 212.

The second camera 210 analyzes the pick action of the human operators. Feedback mechanisms are integrated, and the system is designed to learn and adapt based on the observations made by the camera system during the human pick operation.

The third camera 212 has the role of monitoring and analyzing the pick action performed by the robotic end effectors. Similar to the human work cell, feedback mechanisms are in place, reinforcing the adaptive nature of the system based on robot pick observations.

Referring to FIG. 3, a depiction of a second embodiment of the system designed for monitoring both human and multiple robot work cells is presented, which uses an AI picking complexity evaluation model to make its decisions. Central to this system is its capability to evaluate grasps of different end effectors and direct items to the most suitable robotic end effector.

On the leftmost side, a conveyor 302 conveys items to be inspected by the first camera 304. This camera system is tailored to capture a view of the item layout within a container. Container details can be supplemented from external systems, notably the Order Management System (OMS), Warehouse Management System (WMS), or Warehouse Control System (WCS) 306. Following the visual inspection by the first camera 304, the data is fed into the AI Decision Engine 307. The engine, leveraging deep reinforcement learning techniques, evaluates whether an item is pickable by a robot. This decision-making process is visually represented by a decision point 308 labeled “Is this robot pickable?”.

Items determined to be robot pickable by the AI Decision Engine 307 are directed via another conveyor to a robot work cell. In this embodiment, there are two distinct robot work cells, each catering to different robotic end effectors, and the third camera has become a set of third cameras, each monitoring a different robot work cell.

A first camera 312 of the set of third cameras is responsible for analyzing the pick action of robots within the first Robot Workcell 1. Conversely, a second camera 314 from the third set of cameras oversees the pick action of robots within the second Robot Workcell 2.

Items not deemed robot pickable are directed via a separate conveyor to the Human Workcell which is monitored by the second camera 310. Within this work cell, the second camera 310 monitors and analyzes the pick actions executed by the human operator.

Feedback mechanisms are integrated throughout the system, enhancing the adaptive nature of the AI Decision Engine 307 and other components based on observations made. The feedback loops assist in refining and optimizing the decision-making process and the actions of both the human and robotic operators.

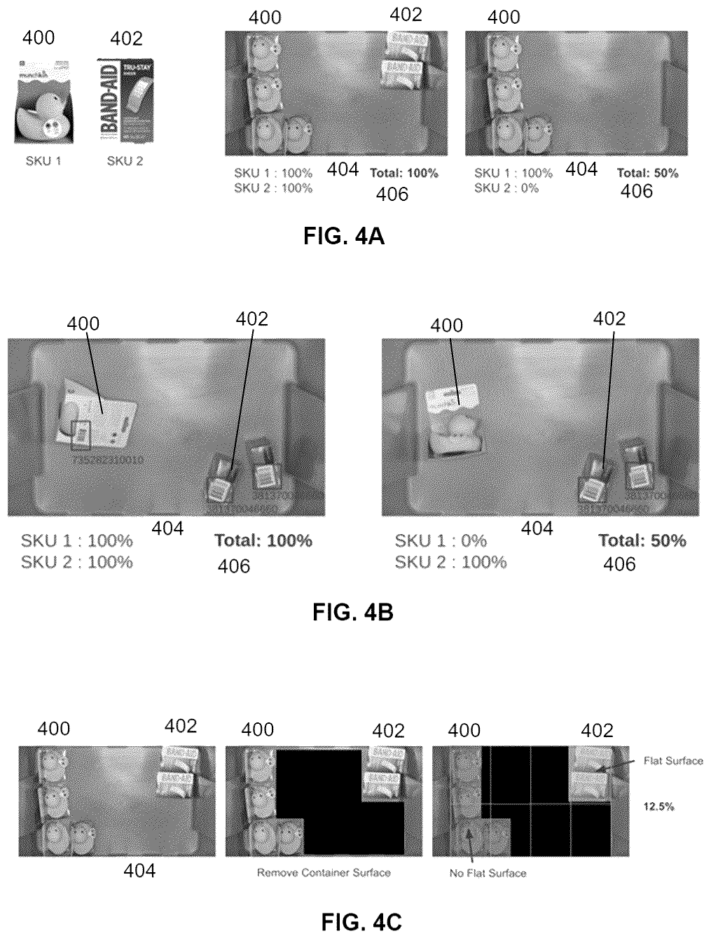

Referring to FIG. 4A, image data captured by the first camera is shown along with insights into the visibility of specific Stock Keeping Units (SKUs) within a given container as determined by the first camera.

To the leftmost side, two distinct SKUs are depicted. The first SKU 400 is a packaged yellow duck toy while the second SKU 402 displays a box containing adhesive bandages.

Centered in the figure are two images captured by the first camera that show the SKUs as contents within an example container 404. The first image showcases both the yellow duck toy 400 from SKU 1 and the bandage box 402 from SKU 2 positioned within the container. Accompanying this image are metrics 406 that indicate SKU visibility, with both SKU 1 and SKU 2 being reported at 100% visibility, resulting in a combined total visibility metric of 100% for the items in the container.

The subsequent image, positioned to the right of the first, presents a different configuration within the same container. Here, only the yellow duck toy 400 from SKU 1 is visible to the first camera. The metrics 406 accompanying this image note a 100% visibility for SKU 1 400 and a 0% visibility for SKU 2 402. Consequently, the combined total visibility metric for this container configuration stands at 50%.

Referring to FIG. 4B, image data captured by the first camera while determining the Barcode visibility Metric for SKU1 400 and SKU2 402 in the example container 404 is shown. The SKUs have been reoriented, so the barcodes are visible.

On the left side of the figure, an image shows the interior of the container 404 with both the rubber duck toy 400 and the bandage box 402 both having their respective barcodes 408 and 410 visible. The accompanying metrics 406 thus indicate a visibility of 100% for the items in this container configuration.

On the right side, alternate image of the container's interior 404 is displayed. In this image, only the second SKU 402 has its barcode visible. The rubber duck toy 400 is oriented so that the barcode is obscured yielding a visibility metric of 0%. The metrics 406 alongside this image thus note a visibility of 0% for SKU 1 and 100% for SKU 2, leading to a combined total visibility metric of 50% for this container arrangement.

Referring to FIG. 4C, the depiction provides a representation of image data captured by the first camera being used to determine the flat surface percentage metric for an example container arrangement.

The figure displays three distinct image processing steps of the same container arrangement. In the leftmost image, the original image of the container is portrayed, showcasing the rubber duck toy 400 and the BAND-AID box 402 in their respective positions in the container.

The middle image is characterized by the removal of the container's visible surface, i.e. the empty space that is not taken up by the SKUs, the rubber duck toy 400 and the bandage box 402 are now suspended against a black backdrop.

In the rightmost image, a grid has been applied to divide the image into multiple sections. The rubber duck toy 400 and the bandage box 402 are both analyzed to determine whether they have a flat surface suitable for an end effector with a suction cup to pick up. The bandages 402 are determined to have a suitable flat surface, while the rubber ducks 400 are determined not to have a suitable surface. Thus only the surface area of the container 404 which is covered by the bandage box SKUs 402 has a suitable flat surface, making up 12.5% of the total surface area within the container 404. This is unlikely to be enough to merit processing by suction cup type end effectors.

Referring to FIG. 4D, image data captured by the first camera is shown capturing the dynamic alterations in the layout of the SKUs 400 and 402 within an example container 404 as it progresses through a warehouse environment. These modifications are registered by the first camera and subsequently stored in the container layout history.

The leftmost image displays the initial arrangement of the rubber duck toy 400 and the bandage boxes 402 within the container. They are placed in organized fashion on opposite sides of the container surface, all in an upright orientation.

The middle image shows a second state of the container's layout. Some of the rubber duck toys 400 have shifted from their original position and one of them is now in a sideways orientation. This transition likely occurs as the container moves or experiences external disturbances within the warehouse environment. The bandage boxes 402 are mostly unmoved.

The rightmost image shows a further alteration in the container's layout. In this state, two of the rubber duck toys 400 have been removed, possibly by warehouse workers, and one of the bandage boxes 402 has also been removed.

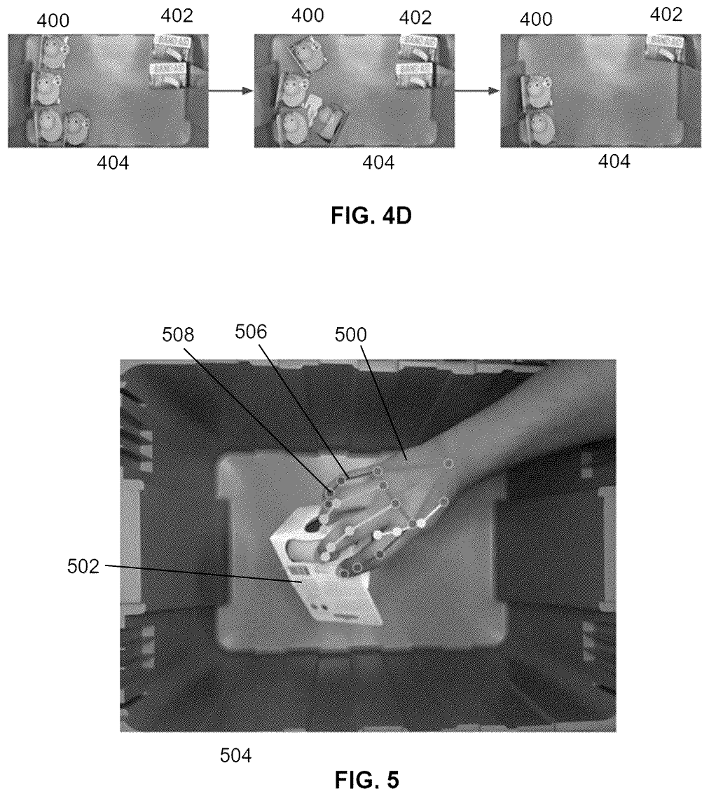

Referring to FIG. 5, the capture and analysis of a person's hand 500 grasping an example item 502 in an example container 504 by the second camera is shown. This illustrates an evaluation of grasp metrics using a skeletal point overlay 506 on the human hand 500.

The skeletal point overlay 506 delineates the structural and positional intricacies of the human hand. Various point nodes 508, connected by lines 510, map the hand's anatomy, from the wrist to the fingertips. Each finger is represented by a series of node points.

These skeletal points aid in the algorithms understanding of how the hand interacts with items in the container, providing essential grasp metrics. The points indicate joints and their relative positions, allowing for the measurement of factors such as angles of flexion, points of contact, and grip strength. By assessing these parameters, the system can evaluate the efficiency and safety of the grasping action, potentially offering insights into optimal hand positioning or identifying areas of strain or discomfort.

### Network Components

A server as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and related methods have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A warehouse optimization system comprising:
a first camera device positioned above a conveyor before a fork point, configured to capture data related to container utilization and item layout in the container, the first camera being further configured to generate a first set of metrics based on the container contents and arrangement;
a second camera device positioned to monitor a human picking station, the second camera being configured to capture data related to manipulation complexity in human item picking and to generate a second set of metrics;
one or more servers configured to:
receive the metrics generated by the first camera, the second camera, and to evaluate a measure of picking complexity and a probability of picking success for a given item based on said metrics; and
based on the measure of picking complexity and the probability of picking success, control the conveyor to direct the given item to a human work cell or a robotic work cell based on the measure of picking complexity and the probability of picking success.

2. The system of claim 1, a third camera device positioned to monitor a robotic picking station, the third camera being configured to capture data related to manipulation complexity in robotic item picking and to generate a third set of metrics; and wherein the servers are further configured to evaluate picking complexity and probability of picking success based on metrics received form the third camera.

3. The system of claim 1, wherein the first set of metrics include one or more of: the percentage of container volume filled, item visibility percentage, barcode visibility percentage, and flat surface percentage.

4. The system of claim 1, wherein the second set of metrics include one or more of: human grasp classification and pick path smoothness.

5. The system of claim 1, wherein the third set of metrics include one or more of: end effector grasp classification and pick path smoothness.

6. The system of claim 1, wherein one or more of the cameras are configured to analyze multi-spectral data including two or more of: 2D images, 3D images, videos, and point clouds.

7. The system of claim 1, wherein the first camera is further configured to capture a dynamic history of container layouts, including stages from inbound to Automated Storage and Retrieval System (ASRS) to picking.

8. The system of claim 1, wherein the second camera is further configured to determine human grasp styles based on The GRASP Taxonomy, which classifies types of grasp into categories including, but not limited to, large diameter grasps and tripod grasp.

9. The system of claim 1, wherein the second camera is further configured to measure the smoothness of the pick motion using an equation for calculating a metric Ja based on the maximum amplitude A of trajectory x(t).

10. The system of claim 1, wherein the third camera is further configured to determine the smoothness of the pick motion of end effectors for specific item types or order lines.

11. The system of claim 1, wherein the control system is further configured to direct items to a robotic workcell when the probability of picking success for that specific robotic workcell is above a predefined threshold.

12. The system of claim 1, wherein the control system is configured to evaluate the probability of picking success for robotic workcells from different vendors in the same warehouse environment.

13. The system of claim 1, wherein the picking complexity and probability of success are calculated using an AI model that is implemented using deep reinforcement learning algorithms for updating the picking complexity assessments continuously.

14. The system of claim 1, wherein the first camera is further configured to determine the feasibility of using a suction cup solution for picking based on the flat surface percentage metric.
